(19) United States
(12) Patent Application Publication
(10) Pub. No.: US 2015/0301987 A1
(43) Pub. Date: Oct. 22, 2015

(54) MULTIPLE MONITOR DATA ENTRY

(71) Applicant: Microsoft Corporation, Redmond, WA (US)

(72) Inventors: Kevin M. Magarian, West Fargo, ND (US); Annette M. Bruer, Fargo, ND (US); Anshuman Gupta, Fargo, ND (US); Sanket Vasa, Fargo, ND (US); Reshma Hegde, Fargo, ND (US)

(73) Assignee: Microsoft Corporation, Redmond, WA (US)

(21) Appl. No.: 14/256,476

(22) Filed: Apr. 18, 2014

(51) Int. Cl. G06F 17/21; G06K 9/58; G06F 3/0484

(52) U.S. Cl. CPC G06F 17/212; G06F 3/04842; G06K 9/58

(57) ABSTRACT

A data entry document is obtained. Information related to the data entry document is displayed on one display device, and a data entry portion of the data entry document is displayed on one or more other display devices. The related information can be from the data entry document, itself, of other information.

### BACKGROUND

Computer systems are currently in wide use. Many computer systems are provided which allow users to perform data entry. Such systems generate displays with data entry portions so that data can be entered into the computer system for later use.

For instance, some such computer systems include business systems. Business systems can include, for example, enterprise resource planning (ERP) systems, customer relations management (CRM) systems, line-of-business (LOB) systems, among others. These types of systems can have many different kinds of documents and thousands of different forms, each of which have fields, line items, or other items for data entry. As one example, a business system may provide functionality for scanning a vendor invoice. When the vendor invoice is scanned, optical character recognition (OCR) can be performed on information in the scanned invoice, and a corresponding business record (such as an invoice document in an ERP system) can be generated. A user then pulls up the captured image of the invoice, along with the document generated in the business system, and performs data entry on the document, while viewing the image of the invoice.

As another example, a user may simply pull up a business document that has a header and footer portion, as well as a data entry portion. For instance, a user may pull up an invoice document in an accounts payable system or in an accounts receivable system to perform data entry on the document. The document may have various portions, such as header and footer portions and data entry portions (such as a line item portion that contains line items) into which the user enters data.

Some current computer systems also have dual monitor functionality. That is, a user of a business system can have different documents displayed on two separate monitors.

The discussion above is merely provided for general background information and is not intended to be used as an aid in determining the scope of the claimed subject matter.

### SUMMARY

A data entry document is obtained. Information related to the data entry document is displayed on a first display device, and a data entry portion of the data entry document is displayed on a second display device. The related information can be a separate item (such as a scanned image or other item), or it can be a portion of the data entry document, itself.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative computing system.

FIG. 2 is a block diagram of one embodiment of a document management system in more detail.

FIG. 3 is a flow diagram illustrating one embodiment of the operation of the system shown in FIG. 1 in generating multi-screen displays.

FIG. 3A shows one embodiment of information displayed on two separate display screens.

FIGS. 3B-1 and 3B-2 (collectively FIG. 3B) show another embodiment of an image displayed on one display screen and a data entry document displayed on the second display screen.

FIG. 4 is a flow diagram illustrating another embodiment of the operation of the system shown in FIG. 1 in generating multi-screen displays.

FIG. 4A shows one embodiment of different information displayed on two separate screens.

FIGS. 4B-4D are illustrative user interface displays.

FIG. 5 shows one embodiment of the business system shown in FIG. 1, deployed in a cloud computing environment.

FIGS. 6-10 show various embodiments of mobile devices.

FIG. 11 is a block diagram of one embodiment of a computing environment.

### DETAILED DESCRIPTION

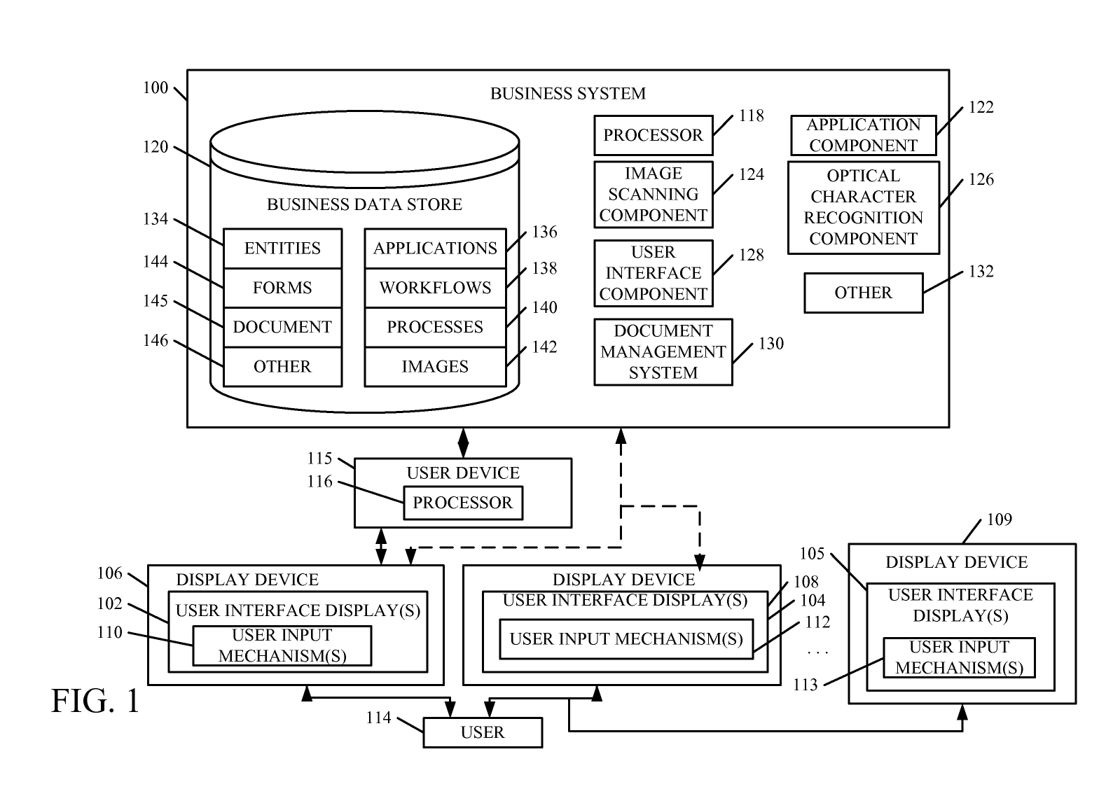

FIG. 1 is a block diagram of one illustrative business system 100. Business system 100 is shown generating user interface displays 102, 104 and 105 on three different display devices 106, 108 and 109. It will be appreciated that the user interfaces described herein can be displayed on two or more display devices and three devices 106, 108 and 109 are shown by way of example only. Each user interface display can have user input mechanisms 110, 112 and 113, respectively. User 114 interacts with user interface displays 102, 104 and 105 (such as through user input mechanisms 110, 112 and 113) in order to interact with, and manipulate, business system 100. User interface displays 102, 104 and 105 can be generated on display devices 106, 108 and 109 by a separate user device 115 (which illustratively includes processor 116) or they can be generated directly be business system 100.

Business system 100 illustratively includes processor 118, data store 120, application component 122, image scanning component 124, optical character recognition (OCR) component 126, user interface component 128, document management system 130 and it can include other items 132 as well. Data store 120, itself, illustratively includes entities 134, applications 136, workflows 138, processes 140, images 142 (that can be scanned into business system 100 using image scanning component 124), forms 144, documents 145 and it can include other business data records or other items 146 as well.

Entities 134 illustratively describe and define entities within business system 100. For instance, a customer entity describes and defines a customer. A vendor entity describes and defines a vendor. An invoice entity describes and defines an invoice. A receipt entity describes and defines a receipt. This list is but a small example of the various different types of entities that can be defined within business system 100.

Applications 136 are illustratively business applications, such as general ledger applications, accounts receivable and accounts payable applications, other accounting applications, inventory tracking applications, as well as a host of other business applications. Application component 122 illustratively runs applications 136, which can include workflows 138, business processes 140, and other items. Workflows 138 and processes 140 illustratively operate on business entities 134, images 142, forms 144, documents 145, and other business records 146. Workflows 138 and processes 140 illustratively enable user 114 to perform his or her tasks within business system 100. The processes and workflows can be automated, semi-automated, or manual.

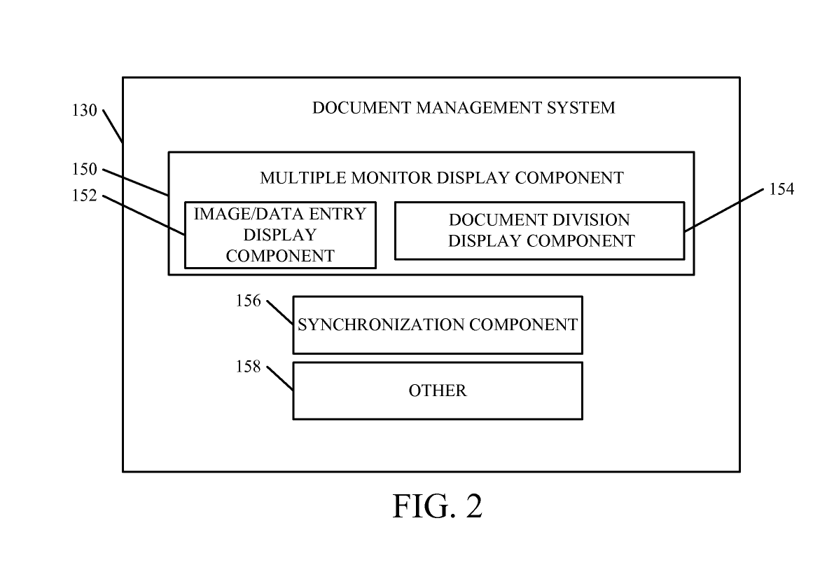

Document management system 130 allows user 114 to perform document management operations on the documents 145 within business system 100. User interface component 128, either by itself, or under the control of other items in business system 110, illustratively generates user interface displays 103, 104 and 105. In one embodiment, document management system 130 allows user 114 to display documents in a multi-screen manner, in which some items corresponding to a document are displayed on screen 106, while other portions of the document are displayed on display device 108 and still other portions can be displayed on device 109. This is described in greater detail below with respect to FIGS. 2-4D.

When an image 142 of a document or other item is scanned into system 100 using image scanning component 124, OCR component 126 can perform optical character recognition operations on the content of the scanned image, and open a corresponding document 145, or other record within business data store 120. For instance, when a user scans a vendor invoice using image scanning component 124, OCR component 126 can perform optical character recognition on the image 142 of the scanned invoice and generate a corresponding entity 134, document 145 or other record 146 within business system 100. This is only one exemplary way of generating documents 145 within business system 100 and they can be generated in other ways as well. For instance, they can be generated automatically, or by a user, without a corresponding image 142.

FIG. 2 is a more detailed block diagram of one embodiment of a portion of document management system 130. Document management system 130 illustratively includes multiple monitor display component 150 which, itself, includes image/data entry display component 152 document division display component 154. Document management system 130 can also illustratively include synchronization component 156 and other items 158. In one embodiment, multiple monitor display component 150 controls the multiple monitor display functionality for business system 100 in displaying information on devices 106, 108 and 109. Again, it will be noted that, in one embodiment, the multiple monitor display functionality is dual monitor display functionality in which information is displayed only on two display devices (106 and 108, for instance). In another embodiment, three or more display devices are used. These are examples only. Before describing the operation of system 100 in performing multiple monitor display operations, a brief overview will be provided.

Image/data entry display component 152 illustratively allows user 114 to display an image of a document on one display device, and display the corresponding business document that is opened within business system 100, on one or more other display devices. Document division display component 154 illustratively allows user 114 to pull up a business document and display some portions of the document on one display device, while displaying the other portions on one or more other display devices.

Both of these display operations increase the display real estate upon which the data entry user input mechanisms (e.g., fields, line items, etc.) can be displayed. This reduces the amount of scrolling and other types of user inputs that need to be provided by user 114 in order to perform data entry and other operations.

Synchronization component 156 illustratively synchronizes the displayed items on display devices 106, 108 and 109. By way of example, assume that business system 100 includes an image of a scanned vendor invoice with a set of line items, and also includes a corresponding business document that corresponds to that invoice and, itself, has a set of line items corresponding to the line items on the scanned vendor invoice. It may also be that user 114 is entering information in line items on the corresponding business document on display device 106, while viewing the line items on the scanned image on display device 108. If the user highlights a portion of the scanned image on display device 108, synchronization component 156 illustratively highlights the same portion of the corresponding business document on device 106. Also, if the user scrolls downwardly on the scanned image on device 108 in order to view additional line items, synchronization component 156 illustratively modifies the display of the displayed document on device 106, as needed, so that it is displaying line items that correspond to the line items being viewed on the scanned image.

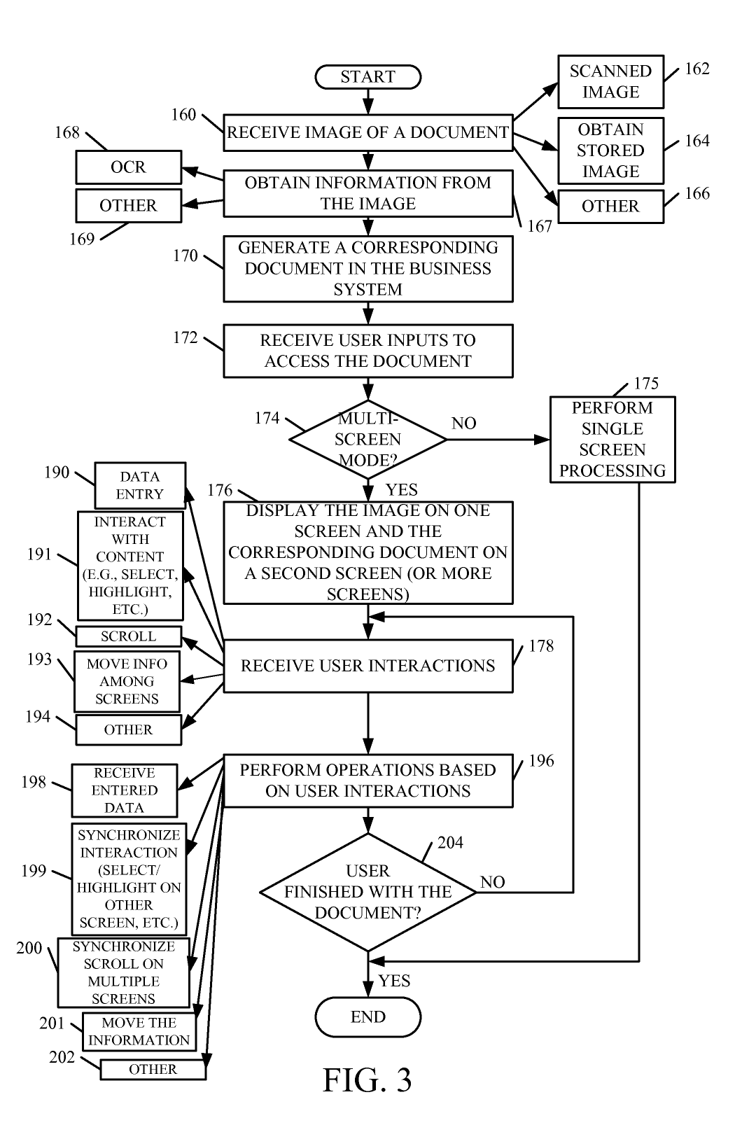

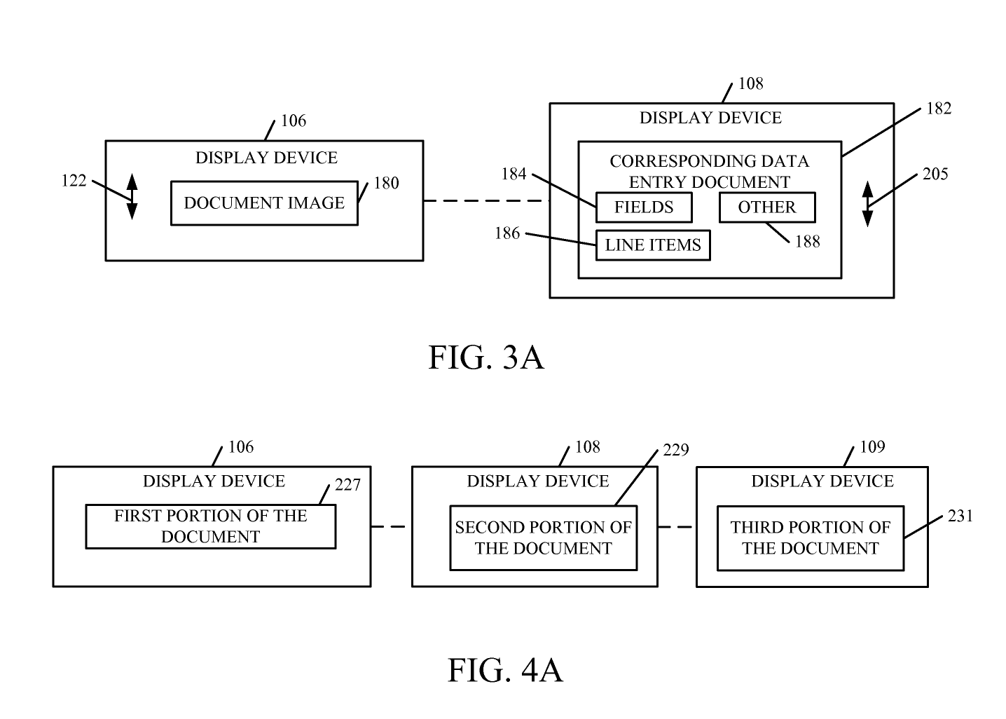

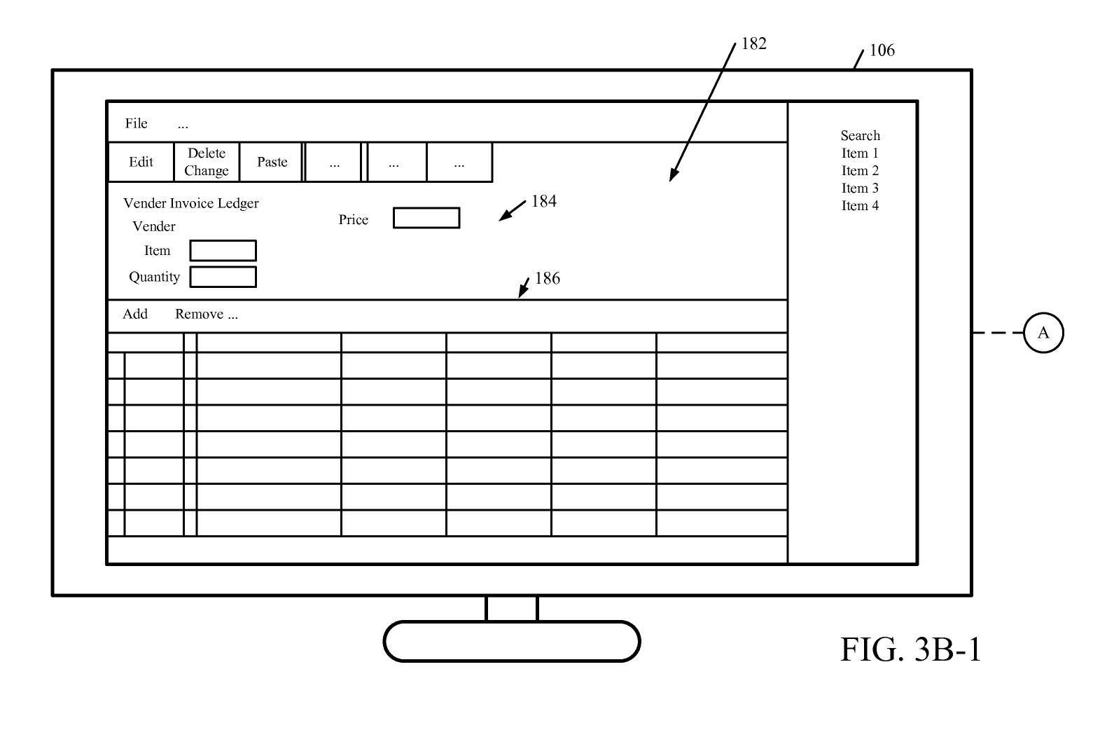

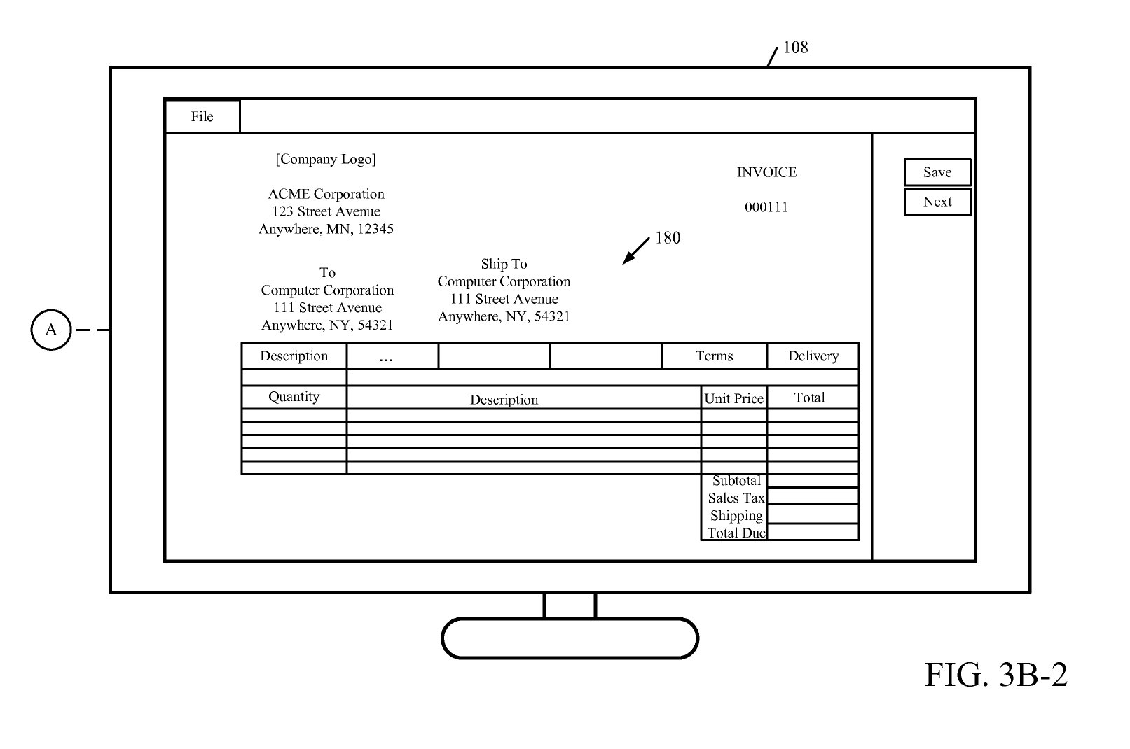

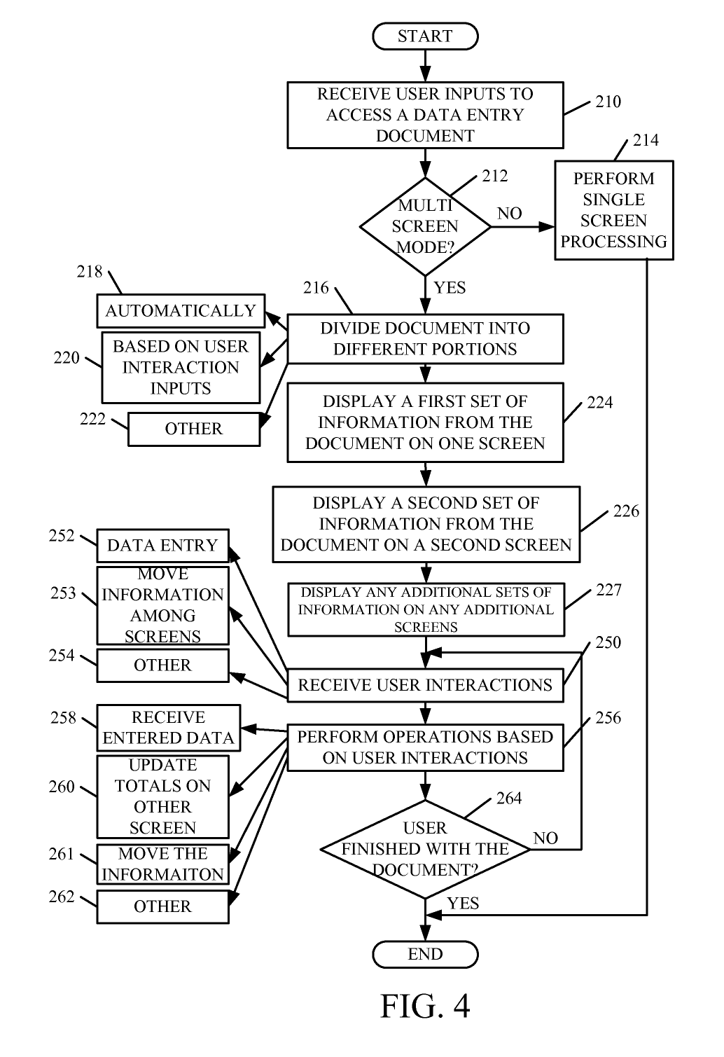

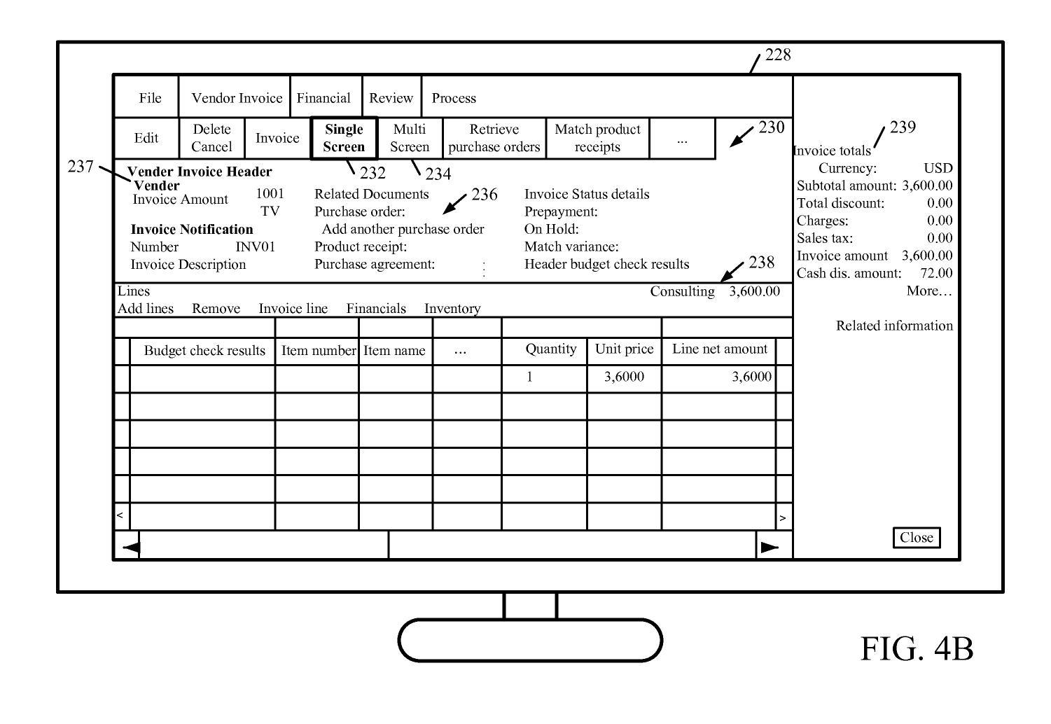

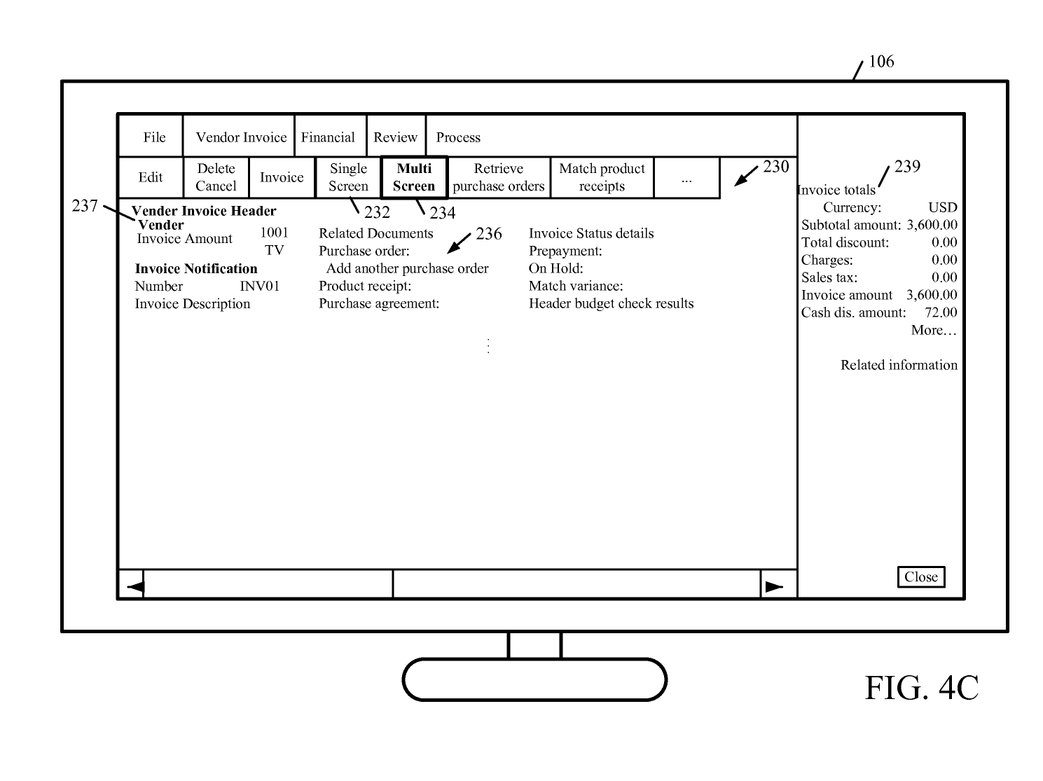

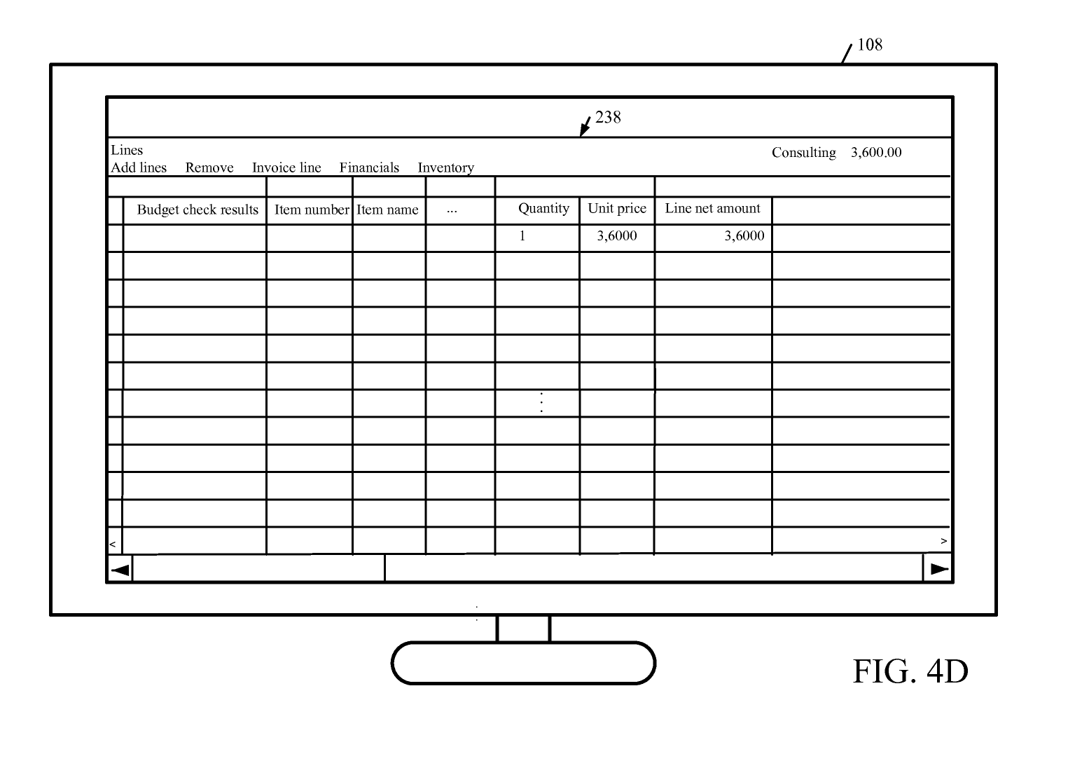

The operation of document management system 130 will now be described in greater detail with respect to FIGS. 3-4D. FIG. 3 is a flow diagram illustrating one embodiment of the operation of business system 100, and document management system 130, in performing multi-screen display operations. FIGS. 3A and 3B are illustrative user interface displays. FIGS. 3-3B will now be described in conjunction with FIGS. 1 and 2.

Business system 100 first receives an image of a document. This is indicated by block 160 in FIG. 3. This can be done in a variety of different ways. As an example, the image of the document can be a scanned image 162, that was scanned using image scanning component 124 in business system 100. Business system 100 can also receive the image of the document from storage, as indicated by block 164, or it can obtain the image of the document in other ways as well, as indicated by block 166.

It will also be noted that the document can be a wide variety of different kinds of documents. It can be an invoice, it can be a receipt, or it can be a wide variety of other business documents for which data entry is to be performed. The system then obtains information from the image so that the corresponding business document can be opened in the business system 100. This is indicated by block 167. This can be done, for instance, by having OCR component 126 perform OCR on the document as indicated by block 168. The information can be obtained in other ways 169 as well.

Document management component 130 then illustratively generates a corresponding business document 145 in business system 100. For instance, if the scanned document is an invoice from a vendor, the document management system 130 illustratively generates a corresponding invoice document within business system 100. Generating the corresponding business document in business system 100 is indicated by block 170 in FIG. 3.

Once the image and the document are generated in business system 100, user 114 illustratively provides user inputs in order to access those items in business system 100. Receiving user inputs to access the document is indicated by block 172 in the flow diagram of FIG. 3. The user may do this for a variety of different reasons. For instance, user 114 can do this in order to perform data entry operations, or for other reasons.

Document management system 130 then accesses the image and the corresponding document. Multiple monitor display component 150 determines whether the system is in multi-screen display mode. This is indicated by block 174 in FIG. 3. As is described in greater detail below, system 100 can enter multi-screen display mode automatically or this can be controlled by the user. If system 130 is not in multi-screen display mode, then processing continues at block 175 where normal, single screen processing is performed.

However, if, at block 174 it is determined that the system is in the multi-screen display mode, then multiple monitor display component 150 displays the captured image on one screen (such as on the display screen of display device 106), and it opens and displays the corresponding document that was generated within the business system 100 on one or more other screens (such as on the display screen of display device 108 or device 109, or both). This is indicated by block 176 of FIG. 3.

FIG. 3A is a block diagram of one embodiment of such a display. It can be seen in FIG. 3A that the document image 180 is displayed on the display screen of display device 106. Also, it can be seen that the corresponding data entry document 182 (that corresponds to the captured image 180) is displayed on the display screen of display device 108. In the embodiment shown in FIG. 3A, the corresponding data entry document 182 illustratively includes fields 184, line items 186, or other items 188, which user 114 uses to enter data.

It can be seen that by displaying the captured image 180 of the scanned document on one display device, and the data entry document on the other display device, a large number of data entry fields 184 or line items 186 or other data entry input mechanisms can be displayed. The scanned image of the document is not taking up any display real estate on display device 108, so that real estate can be devoted to data entry.

FIGS. 3B-1 and 3B-2 (collectively FIG. 3B) show a more detailed embodiment of such a multi-screen display. FIG. 3B is similar to FIG. 3A, except that the captured image of the document 180 is displayed on the display screen of display device 108, while the corresponding data entry document 182 is displayed on the display screen of display device 106. It can be seen in the example shown in FIG. 3B that the corresponding document 182 has fields 184 for data entry, along with line items 186. While the user is performing data entry on document 182 on display device 106, the user can be simultaneously viewing the captured image 180 on display device 108. However, because the scanned image 180 is not displayed on the same display device as document 182 (e.g., on device 106) the display on device 106 can show a substantially greater number of data entry items (such as fields 184 and line items 186) because the scanned image 180 is not consuming any of the display real estate on device 106.

Once multiple monitor display component 150 has generated the displays (such as those shown in FIGS. 3A and 3B, for example), document management system 130 illustratively receives user interactions with the displayed items. This is indicated by block 178 in the flow diagram of FIG. 3. The user interactions can take a wide variety of different forms. For instance, they can be data entry interactions 190, they can be interactions with content (such as highlight or select) 191, they can be scroll interactions 192, they can be interactions 193 (like drag/drop) to move some of the displayed information onto yet another display device (like device 109) or other interactions 194.

In response, document management system 130 illustratively performs operations based on the user interactions. This is indicated by block 196. For instance, if the user performs data entry by typing in textual data, document management system 130 receives that data on the displayed document or form. This is indicated by block 198. If the user interacts with content on one of the displays (such as by highlighting it), the synchronization component 156 highlights the corresponding portion of the other display. This is indicated by block 199. If the user provides a scroll input to scroll either the captured image of the document, or the corresponding data entry document that was opened in business system 100, then synchronization component 156 illustratively scrolls the device, as indicated by the user, and also synchronizes the display of the other device, based upon the scroll input. This is indicated by block 200 in FIG. 3.

By way of example, and referring again to FIG. 3A, it may be that the user wishes to scroll the captured image 180 displayed on display device 106 upwardly or downwardly in the direction indicated by arrow 202. The user may do this to see additional line items or other information that is not currently being displayed. In response, synchronization component 156 controls scrolling of the corresponding data entry document 182, also in the direction indicated by arrow 204, so that the display on device 108 corresponds to the display on device 106. By way of a specific example, if the captured image 180 is an invoice with 100 line items, it may be that the user first has the display of image 180 set so that the user can view the first 50 line items in the invoice. The user then performs data entry on document 182 on display device 108 based on the first 50 line items of the image 180 displayed on device 106. When that is complete, the user may scroll the image 180 so that the user can see line items 51-100 of the image 180. Synchronization component 156 then scrolls document 182 on display device 106 so that the data entry lines corresponding to line items 51-100 on image 180 are displayed on document 182 as well. In another embodiment, component 156 simply ensures that the first line being displayed on image 180 corresponds to the first line being displayed in document 182. Other scrolling operations can be performed as well.

In another embodiment, scroll synchronization is performed automatically, without any user input. Assume again that the user is viewing line items 1-50 of document image 180 on device 106. Assume also that the user has just completed data entry on line item 50 in the corresponding data entry document 182 on device 108. In one embodiment, document management system 130 automatically scrolls the document 182 to expose data entry field 151. Synchronization component 156 can then automatically scroll the image 180 on display 106 so that it shows the corresponding line item of the captured image 180.

The user may also interact with the displayed information by providing inputs to move some of the information onto another display device. As an example, assume that the user is performing data entry on line items on the data entry document, but the user comes to a line where the user has questions and needs to call the customer before entering the information for that line item. In one embodiment, the user can move that line item onto a separate display device that displays lines that the user is to return to for further action (like calling the customer). The user can do this, for instance, by selecting a line item and performing a drag and drop operation or another operation. In response, document division display component 154 divides that line item from the original display, and places it on the display of the items awaiting further action. Moving the information to a different display devices is indicated by block 201.

It will be noted that document management system 130 can perform other operations based on other user interactions with the displayed items. This is indicated by block 202 in the flow diagram of FIG. 3. At some point, the system will determine that the user has finished with the document. By way of example, the user may provide inputs indicating that the user wishes to save and close the document, etc. Until the user does this, processing continues at blocks 178-202. This is indicated by block 204.

FIG. 4 is a flow diagram showing one embodiment of the operation of business system 100 in performing multi-screen display operations where the system either automatically splits, or the user wishes to split the display of a single document into two or more sections on two or more display devices. For instance, one displayed section illustratively includes a first portion of the information (such as header and footer information, etc.) and the other display includes a second portion of the information (such as fields, line items, etc.). By splitting the document in this way, a large number of data entry fields or line items can be displayed, because the header, footer or other portions of the document are not consuming any display real estate on the display device that is showing the line item portion of the document.

Document management system 130 first receives user inputs indicating that the user wishes to access a data entry document in business system 100. This is indicated by block 210 in FIG. 4.

Again, document management system 130 determines whether the system is in the multi-screen display mode. This is indicated by block 212. In one embodiment, the system automatically enters the multi-screen display mode upon detecting that two display devices are connected. In another embodiment, component 154 automatically detects that the header/footer portions of the document and the line item portions of the document cannot all be displayed on a single display screen. In another embodiment, the system allows the user to provide an input to indicate that the user wishes the system to be in the multi-screen display mode. In yet another embodiment, the system can automatically enter that mode, and allow the user to override it. All of these and other configurations are contemplated herein.

If the system is not in multi-screen display mode, then processing continues in the normal, single screen mode. This is indicated by block 214.

Assuming that the system is in the multi-screen display mode, component 154 divides the document into different portions that are to be displayed on the different display devices. This is indicated by block 216. Again, this can be done automatically as indicated by block 218, based on user inputs as indicated by block 220, or in other ways as indicated by block 222. Multiple monitor display component 150 then displays a first set of information from the data entry document on one screen and a second set of information from the same data entry document on the second screen, and it can further divide the display onto other screens as well. This is indicated by blocks 224, 226 and 227 in the flow diagram of FIG. 4. FIG. 4A shows one embodiment of this.

It can be seen in FIG. 4A that display device 106 displays a first portion 227 of the document on device 106. This can include, for instance, header and footer information or other information. FIG. 4A also shows that device 108 displays the second portion 229 of the document on display device 108. This can include fields, line items, etc., where the user performs repetitive data entry operations. FIG. 4A shows that the third portion 231 of the document can be displayed on a third device 109 and so on. A more specific example of this is described with respect to FIGS. 4B-4D.

FIG. 4B shows one embodiment of a user interface display 228 of a data entry document 230 that has not yet been split. It can be seen in the embodiment shown in FIG. 4B that the user is provided a user input mechanism 232 that can be actuated by the user to place the system in single screen display mode. The user is also provided with a user input mechanism 234 that allows the user to enter the multi-screen display mode. It can be seen in FIG. 4B that the user is in the single-screen display mode.

It can also be seen that document 230 illustratively includes first portion 236 and a second portion 238. First portion 236 illustratively includes header portion 237 and totals portion 239. Header portion 237 displays a variety of different types of header information. That information can include vendor identification information, a related document section, various detail information and date sections, etc. Totals portion 239 illustratively includes information that is updated based on data entered in the second portion 238. For example, totals portion 239 includes totals that are aggregated from line items in the second portion 238. Thus, in one embodiment, as the user enters numerical information in the line items of portion 238, the totals in totals section 239 are automatically updated.

FIG. 4B also shows that data entry portion 238 displays a set of line items on which data is to be entered. The user performs repetitive data entry operations to enter data into portion 238. This is but one example of a portion 238 of a document.

When the user actuates the multi-screen user input mechanism 234, multiple monitor display component 150 of document management system 130 illustratively divides the display shown in FIG. 4B into two separate portions that are separately displayed on display devices 106 and 108 (and possibly on more display devices). FIG. 4C shows that the user has now actuated multi-screen user input mechanism 234. Thus, component 154 of document management system 130 divides the display of FIG. 4B into two separate displays. The first portion 236 of the document is displayed as shown in FIG. 4C, on the display screen of device 106. The second portion 238 of the document is simultaneously displayed as shown in FIG. 4D, on the display screen of device 108. When displayed in this way, the header portion 237 and totals portion 239 do not consume any display real estate on device 108. Therefore, a larger number of line items can be displayed for data entry on device 108. Of course, the display can be split among additional display devices as well, and the two shown in FIGS. 4C and 4D are exemplary only.

The user then illustratively interacts with the displays on devices 106 and 108. Interacting with the displays is indicated by block 250 in the flow diagram of FIG. 4. The user interactions can include such things as data entry 252, moving information among the various displays as indicated by block 253 or a wide variety of other user interactions 254.

In response, document management system 130 performs operations on the document, based upon the user interactions. This is indicated by block 256. For instance, where the user is entering information in the line items in FIG. 4D, document management system 130 receives the entered data. This is indicated by block 258.

In one embodiment, as the user is entering numerical information on the line items of display device 108, document management system 130 illustratively updates the totals section 239 in the display on device 106. This is indicated by block 260 in FIG. 4.

Where the user provides inputs to move information from one display to another or to otherwise divide the information into more displays, system 130 performs the desired operation. This is indicated by block 261.

Of course, these are only some examples of user interactions and corresponding operations, and others can be performed as well. This is indicated by block 262.

At some point, the user will finish with the document. Until that point, processing simply reverts to blocks 250 and 256. This is indicated by block 264 in FIG. 4.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

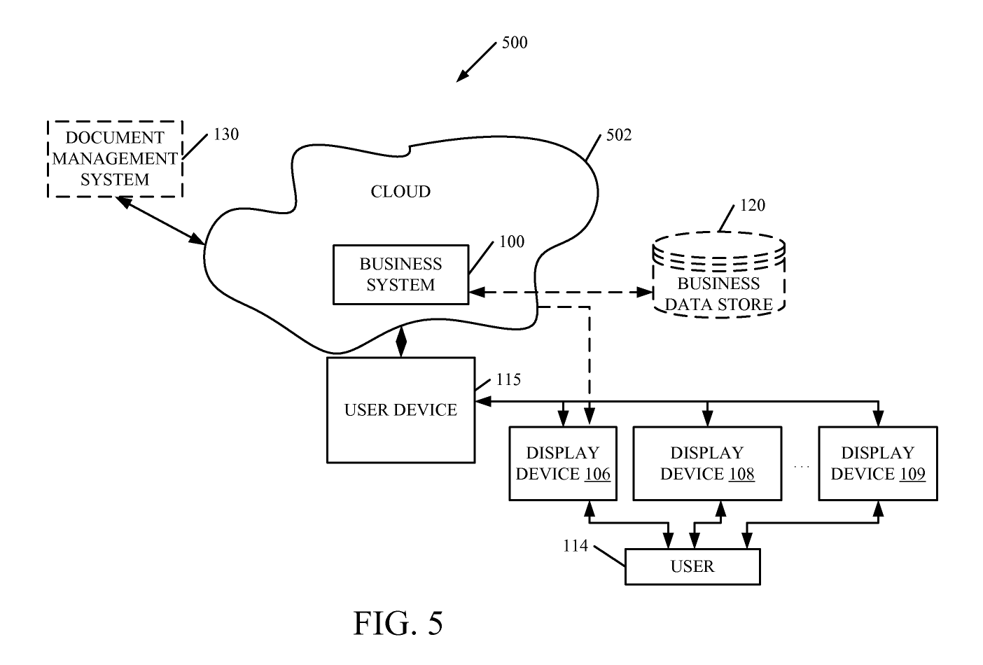

FIG. 5 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 5, some items are similar to those shown in FIG. 1 and they are similarly numbered. FIG. 5 specifically shows that business system 100 can be located in cloud 502 (which can be public, private, or a combination where portions are public while others are private). Therefore, user 114 uses a user device 115 to access those systems through cloud 502.

FIG. 5 also depicts another embodiment of a cloud architecture. FIG. 5 shows that it is also contemplated that some elements of system 100 can be disposed in cloud 502 while others are not. By way of example, data store 120 can be disposed outside of cloud 502, and accessed through cloud 502. In another embodiment, system 130 is also outside of cloud 502. Regardless of where they are located, they can be accessed directly by device 115, through a network (either a wide area network or a local area network), they can be hosted at a remote site by a service, or they can be provided as a service through a cloud or accessed by a connection service that resides in the cloud. All of these architectures are contemplated herein.

It will also be noted that system 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

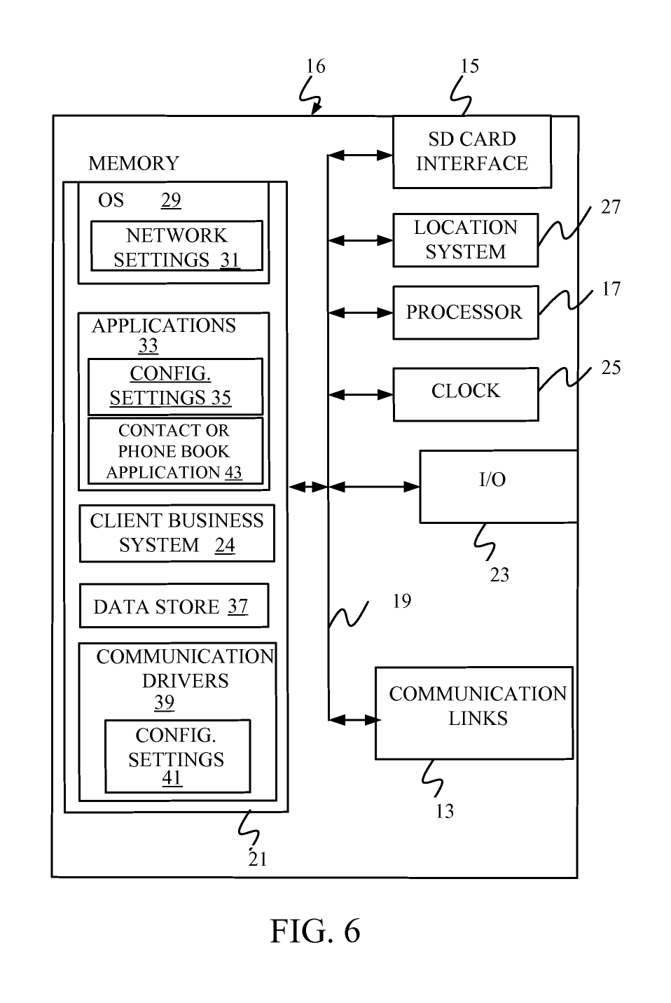

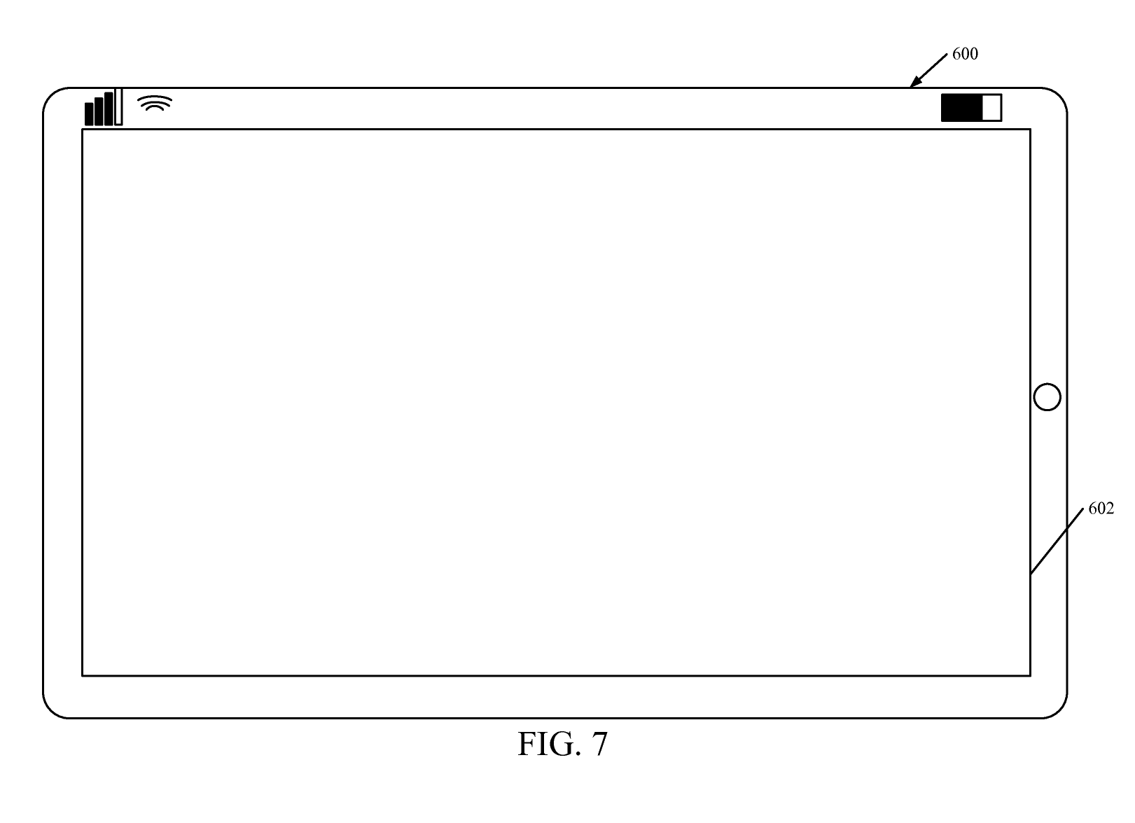

FIG. 6 is a simplified block diagram of one illustrative embodiment of a handheld or mobile computing device that can have a display screen and can be used as one of devices 106 or 108. It can be used as a user's or client's hand held device 16, in which the present system (or parts of it) can be deployed. FIGS. 7-10 are examples of handheld or mobile devices.

FIG. 6 provides a general block diagram of the components of a client device 16 that can run components of system 100 or that interacts with system 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processors 116 or 118 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 7 shows one embodiment in which device 16 is a tablet computer 600. In FIG. 7, computer 600 is shown with user interface display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

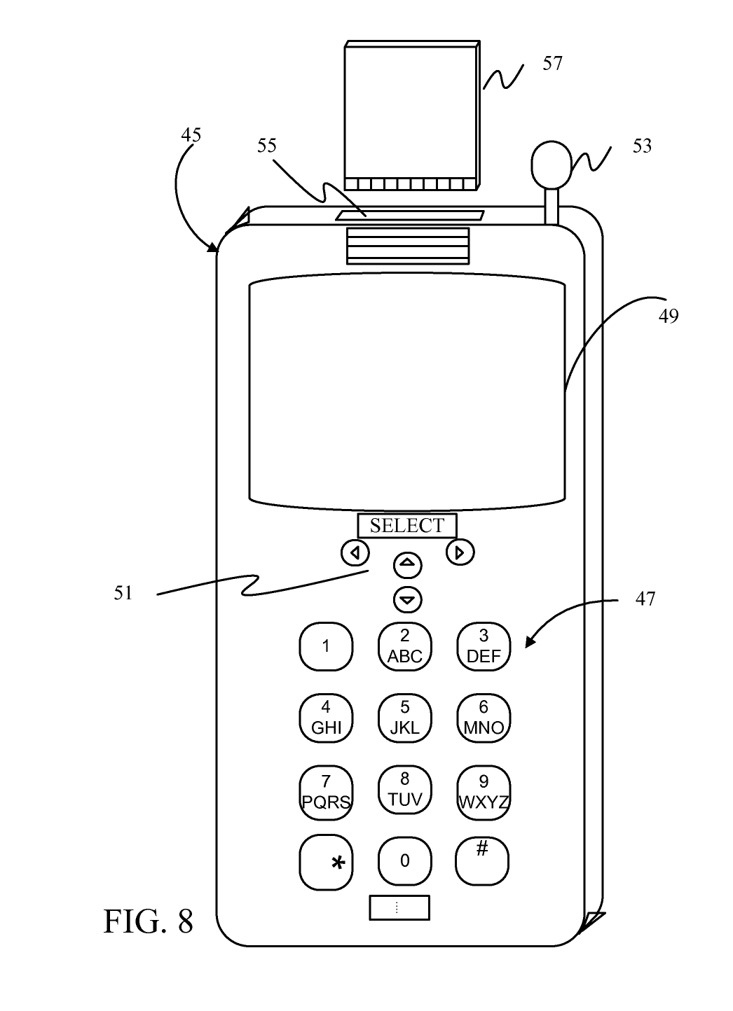

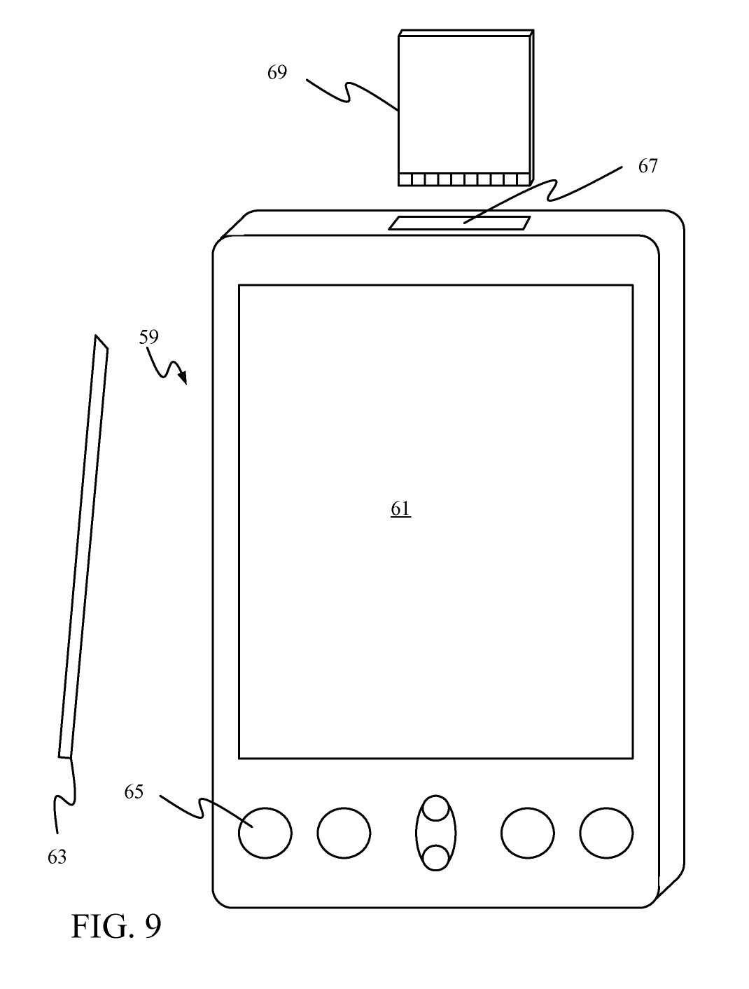

FIGS. 8 and 9 provide additional examples of devices 16 that can be used, although others can be used as well. In FIG. 8, a feature phone, smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 9 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

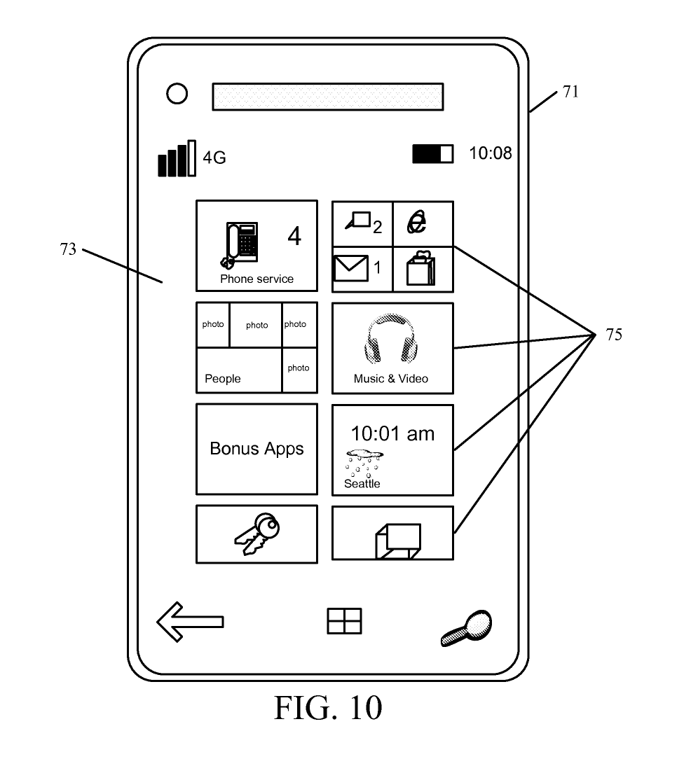

FIG. 10 is similar to FIG. 8 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

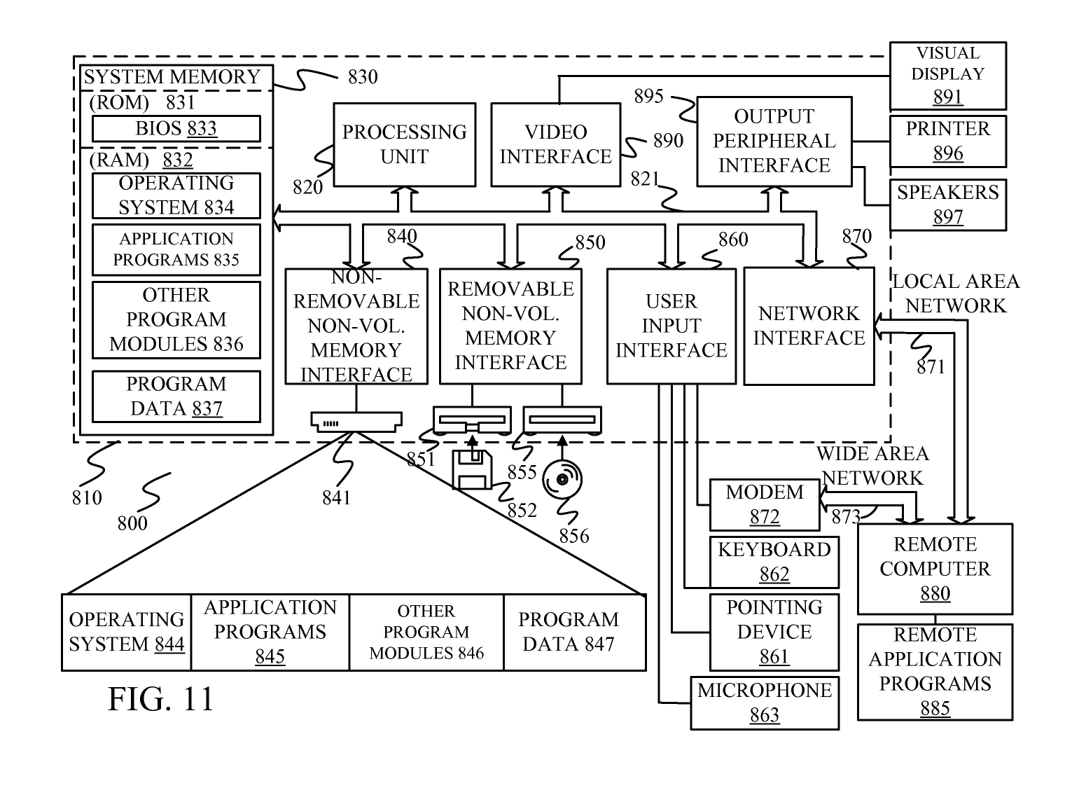

FIG. 11 is one embodiment of a computing environment in which system 100, or parts of it, (for example) or device 115 can be deployed. With reference to FIG. 11, an exemplary system for implementing some embodiments includes a general-purpose computing device in the form of a computer 810. Components of computer 810 may include, but are not limited to, a processing unit 820 (which can comprise processor 116 or 118), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 11.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 11 illustrates operating system 834, application programs 835, other program modules 836, and program data 837.

The computer 810 may also include other removable/non-removable volatile/nonvolatile computer storage media. By way of example only, FIG. 11 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 11, provide storage of computer readable instructions, data structures, program modules and other data for the computer 810. In FIG. 11, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 11 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 11 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method, comprising:
obtaining, from a computer system, a data entry document that has a first portion that comprises a data entry portion that receives user-entered data;
displaying related information, corresponding to the data entry document, on a display screen of a first display device; and
displaying the first portion of the data entry document on a display screen of a second display device.

2. The computer-implemented method of claim 1 wherein the computer system comprises a business system and the data entry document comprises a business document and wherein displaying related information comprises:
displaying a second portion of the business document on the display screen of the first display device.

3. The computer-implemented method of claim 2 wherein displaying the data entry portion comprises:
displaying at least one of a set of fields and a set of line items that receive user-entered data on the display screen of the second display device.

4. The computer-implemented method of claim 2 wherein displaying the second portion comprises:
displaying header information for the business document on the display screen of the first display device.

5. The computer-implemented method of claim 2 and further comprising:
receiving the user-entered information on the data entry portion of the business document displayed on the display screen of the second display device; and
updating the second portion of the business document on the display screen of the first display device based on the user-entered information received on the data entry portion of the business document on the display screen of the second display device.

6. The computer-implemented method of claim 1 wherein the computer system comprises a business system and the data entry document comprises a business document and wherein displaying related information comprises:
capturing an image of a received document corresponding to the business document; and
displaying the image on the display screen of the first display device.

7. The computer-implemented method of claim 6 and further comprising:
in response to capturing the image, creating the corresponding business document in the business system.

8. The computer-implemented method of claim 7 wherein capturing the image comprises:
scanning the received document to obtain the image; and
performing optical character recognition on the image.

9. The computer-implemented method of claim 6 and further comprising:
receiving a user interaction input on a given display of the displayed image and the displayed business document;
modifying the given display based on the user interaction input to obtain a modified display; and
synchronizing another of the displayed image and the displayed business document based on information on the modified display.

10. The computer-implemented method of claim 9 wherein receiving a user interaction input comprises receiving a scroll command on the given display, wherein modifying the given display comprises scrolling the given display based on the scroll command to obtain a scrolled display, and wherein synchronizing comprises automatically scrolling the other display based on information on the scrolled display.

11. The computer-implemented method of claim 1 wherein the data entry document also has a second portion and further comprising:
dividing the data entry document into the first and second portions; and
displaying the first and second portions on different display devices.

12. A computer system, comprising:
an application component that runs an application that processes user-entered data, entered into a first portion of a data entry document;
a first display device having a display screen;
a second display device having a display screen; and
a document management system that displays information, corresponding to the data entry document, on the display screen of the first display device, and displays portions of the document on the display screen of the second display device.

13. The computer system of claim 12 and further comprising:
a computer processor that is a functional part of the system and activated by the application component and the document management system to facilitate running the application and displaying the portions of the data entry document and the information corresponding to the data entry document.

14. The computer system of claim 12 wherein the application comprises a business application, the information corresponding to the data entry document comprises an image of a received document and wherein the data entry document comprises a corresponding business document generated in the business system based on receipt of the received document.

15. The computer system of claim 14 wherein the document management system comprises:
an image/data entry display component that displays the image of the received document on the display screen of the first display device and displays the corresponding business document on the display screen of at least the second display device.

16. The computer system of claim 15 and further comprising:
a synchronization component that receives a command to manipulate a given display on one of the first and second display devices to obtain a modified display and that automatically synchronizes another of the displays on the first and second display devices based on information displayed on the modified display.

17. The computer system of claim 12 wherein the application comprises a business application, wherein the data entry document comprises a business document generated in the business system, and wherein the information corresponding to the data entry document comprises second and third portions of the data entry document other than the first portion, and further comprising at least a third display device, wherein the document management system divides the business document into at least the first, second and third portions and displays each portion on a separate one of the at least first, second and third display devices.

18. The computer system of claim 17 wherein the second portion of the data entry document includes a value portion that has a value that is based on the user-entered data in the first portion and wherein the document management system automatically updates the value portion displayed on the display screen of one of the first, second and third display devices based on the user-entered data entered in the first portion displayed on the display screen of another of the first, second and third display devices.

19. A computer readable medium that stores computer executable instructions which, when executed by a computer, cause the computer to perform a method, comprising:
obtaining, from a computer system, a data entry document that has multiple different portions;
dividing the data entry document into the multiple different portions; and
displaying each of the multiple different portions of the data entry document on a separate one of a plurality of different display devices.

20. The computer readable storage medium of claim 19 wherein the computer system comprises a business system and the data entry document comprises a business document, wherein a first of the multiple different portions comprises a data entry portion, and further comprising:
receiving user-entered information on the data entry portion of the document displayed on the display screen of a first of the display devices; and
updating a second portion of the business document other than the data entry portion, displayed on the display screen of a second of the display devices, based on the user-entered information received on the data entry portion of the business document on the display screen of the first display device.
